(19) United States
(12) Patent Application Publication
(10) Pub. No.: US 2007/0299206 A1
(43) Pub. Date: Dec. 27, 2007

(54) LACTAM POLYMER DERIVATIVES

(76) Inventors: Kevin Cooper, Flemington, NJ (US); Ankur S. Kulshrestha, Jersey City, NJ (US); Walter R. Laredo, Fort Worth, TX (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/764,303

(22) Filed: Jun. 18, 2007

Related U.S. Application Data
(63) Continuation-in-part of application No. 11/472,667, filed on Jun. 22, 2006.

(51) Int. Cl. C08G 63/08

(52) U.S. Cl. 525/54.1; 525/419

(57) ABSTRACT

Crosslinked lactam polymers are disclosed. Specifically, lactam polymers having pendant acrylate groups are crosslinked via a Michael addition type acrylate reactant. The crosslinked lactam polymers are useful in medical and pharmaceutical applications. Also disclosed are methods for making hydroxyl-functionalized lactam polymer derivatives.

### CROSS-REFERENCE TO RELATED APPLICATION

This application is a continuation-in-part application of U.S. application Ser. No. 11/472667 filed on Jun. 22, 2006 (Attorney Docket No. ETH 5295), which is incorporated herein by reference in its entirety.

### FIELD OF THE INVENTION

The present invention relates to lactam polymer derivatives, such as hydroxyl-functionalized lactam polymers and derivatives thereof, and crosslinked lactam polymers. More particularly, the present invention relates to crosslinked polymers derived from lactam polymers that have been functionalized with pendant acrylate groups, and methods for making and using the same. The present invention further relates to methods for making hydroxyl-functionalized lactam polymer derivatives.

### BACKGROUND OF THE INVENTION

Degradable crosslinked polymer networks are important in a number of biotechnological and medical applications such as drug delivery, tissue engineering, implantable devices, and in situ gelling materials. The presence of degradable linkages eliminates the need for long-term biocompatibility or surgical retrieval of the implanted polymer. Degradable networks are advantageous in tissue engineering, where a temporary scaffold is needed for structural support, cell attachment, and growth.

Poly(N-vinyl-2-pyrrolidone), also known as polyvinylpyrrolidone, PVP, Povidone, or Plasdone, is a water-soluble lactam polymer used commercially in such products as aerosol hair sprays, adhesives, lithographic solutions, pigment dispersions, and drug, detergent, and cosmetic formulations. The general class of lactam polymers, including PVP, are well known, as described for example in Robinson, B. V., et. al., “PVP: A Critical Review of the Kinetics and Toxicology of Polyvinylpyrrolidone (Povidone)”, (1990); U.S. Pat. Nos. 3,153,640, 2,927,913, 3,532,679; and Great Britain Patent Number 811,135. PVP has been used extensively in medicine since 1939. The earliest use of PVP in medicine was during World War II when a 3.5% solution of PVP was infused into patients as a synthetic blood plasma volume expander. The toxicity of PVP, extensively studied in a variety of species including humans and other primates, is extremely low. PVP has also found use as internal wetting agents in contact lens applications.

The preparation of functionalized lactam polymers with pendant acrylate groups have been described in U.S. Patent Publication 20060069235 (“'235 Publication”). In general, the '235 Publication describes first treating lactam polymers with a reducing agent to form lactam polymers functionalized with hydroxyl groups. The hydroxyl-functionalized lactam polymers were then further functionalized with a hydroxyl reactive compound containing an acrylate group to form the acrylate-functionalized lactam polymers. More specifically, lactam polymers were dissolved in a protic solvent with a reducing agent and heated between 40° C. and 90° C. for up to two days. After purification by precipitation, the resultant hydroxyl-functionalized lactam polymer was then further functionalized with a hydroxyl-reactive compound containing an acrylate group, such as acryloyl chloride. In the case of acryloyl chloride, the acrylate-functionalized lactam polymer was prepared by the acryloylation of the hydroxyl groups on the hydroxyl-functionalized lactam polymer in an inert organic solvent containing an acid scavenger. The hydrochloride salt was removed by filtration and the polymer was recovered by removing the solvent by rotary evaporation. Lastly, the acrylate-functionalized lactam polymer was purified by precipitation.

The '235 Publication also describes the preparation of crosslinked polymer hydrogels from acrylate-functionalized lactam polymers. The crosslinking reactions were accomplished through free radical polymerization. The free radical polymerization was initiated by using thermal initiators and heat or by using photo initiators and ultraviolet or visible light. The kinetics of free radical polymerization usually results in the formation of high molecular weight polymer chains. Although high molecular weight polymers may be useful for certain applications, such as in contact lenses, the high molecular weight chains generated by free radical polymerization may not be favorable for certain biomedical applications. The resultant polymer cannot be easily eliminated from the body due to its large hydrodynamic volume. For example, free radical polymerization of acrylate-functionalized lactam polymers will result in a crosslinked network containing polyacrylate segments covalently linked to the modified lactam polymer. The crosslinked network, when hydrolyzed, will give a lactam polymer of known molecular weight range (the same molecular weight of the starting lactam polymer). However, polyacrylic acid of various molecular weights is possible, including high MW. There is little control over the molecular weight of these chains without adding the additional complication of chain transfer agents. Additionally, for photopolymerized polymers, light attenuation by the initiator restricts the maximum attainable cure depth to a few millimeters. Therefore, photopolymerized polymers are not applicable to biomedical applications where the polymer or device needs to be more than just a few millimeters in thickness.

In view of the deficiencies in using free radical chemistry to crosslink a functionalized lactam polymer in certain biomedical applications such as, in implantable biodegradeable medical devices or in in situ polymerizable medical devices, it would be desirable to crosslink a lactam polymer using alternative chemistry.

In view of PVP's long standing use in biomedical applications, as well as the benefits associated with PVP derivatives, such as hydroxyl-functionalized polyvinylpyrrolidones, which have reactive moieties along the polymer backbone that can be reacted to form new polymers having desirable properties, it would also be beneficial to have improved methods to make hydroxyl-functionalized polyvinylpyrrolidones having hydroxyl moieties distributed randomly throughout the polyvinylpyrrolidone backbone.

### SUMMARY OF THE INVENTION

The invention is a crosslinked lactam polymer. The crosslinked lactam polymer comprises the reaction product of a) a lactam polymer which is functionalized with a pendant acrylate group, and b) a Michael Addition type acrylate reactant.

The crosslinked lactam polymers of this invention are particularly useful for medical and pharmaceutical applications. For example, the polymers can be used for tissue augmentation, delivery of biologically active agents, hard tissue repair, hemostasis, adhesion prevention, tissue engineering applications, medical device coatings, adhesives and sealants, and the like.

The invention is also directed to a method for synthesizing a hydroxyl-functionalized lactam polymer or copolymer derivative as set forth in the claims.

### DETAILED DESCRIPTION OF THE INVENTION

It is believed that one skilled in the art can, based upon the description herein, utilize the present invention to its fullest extent. The following specific embodiments are to be construed as merely illustrative, and not limitative of the remainder of the disclosure in any way whatsoever.

Unless defined otherwise, all technical and scientific terms used herein have the same meaning as commonly understood by one of ordinary skill in the art to which the invention belongs. Also, all publications, patent applications, patents, and other references mentioned herein are incorporated by reference in their entireties. As used herein, all percentages are by weight unless otherwise specified. In addition, all ranges set forth herein are meant to include any combinations of values between the two endpoints, inclusively.

In one embodiment, lactam polymers functionalized with pendant acrylate groups may be prepared in accordance with the method described in the '235 Publication. These functionalized lactam polymers are comprised of repeating units derived from substituted and unsubstituted lactam monomers in the polymer backbone. A percentage of the lactam repeating units is initially converted to secondary or tertiary hydroxy alkyl amines and subsequently to acrylates, which are randomly distributed throughout the polymer backbone. Suitable lactam monomers include but are not limited to substituted and unsubstituted 4 to 7 membered lactam rings. Suitable substituents include but are not limited to C1-3 alkyl groups and aryl groups. Examples of suitable lactam monomers include N-vinyl lactams such as N-vinyl-2-pyrrolidinone, N-vinyl-2-piperidone, N-vinyl-epsilon-caprolactam, N-vinyl-3-methyl-2-pyrrolidone, N-vinyl-3-methyl-2-piperidone, N-vinyl-3-methyl-2-caprolactam, N-vinyl-4-methyl-2-pyrrolidone, N-vinyl-4-methyl-2-caprolactam, N-vinyl-5-methyl-2-pyrrolidone, N-vinyl-5-methyl-2-piperidone, N-vinyl-5,5-dimethyl-2-pyrrolidone, N-vinyl-3,3,5-trimethyl-2-pyrrolidone, N-vinyl-5-methyl-5-ethyl-2-pyrrolidone, N-vinyl-3,4,5-trimethyl-3-ethyl-2-pyrrolidone, N-vinyl-6-methyl-2-piperidone, N-vinyl-6-ethyl-2-piperidone, N-vinyl-3,5-dimethyl-2-piperidone, N-vinyl-4,4-dimethyl-2-piperidone, N-vinyl-7-methyl-2-caprolactam, N-vinyl-7-ethyl-2-caprolactam, N-vinyl-3,5-dimethyl-2-caprolactam, N-vinyl-4,6-dimethyl-2-caprolactam, N-vinyl-3,5,7-trimethyl-2-caprolactam, N-vinylmaleimide, N-vinylsuccinimide, and mixtures thereof and the like.

In one embodiment, lactam monomers are substituted and unsubstituted 4 to 6 membered lactam rings. Suitable lactam monomers are N-vinyl-2-pyrrolidinone, N-vinyl-2-piperidone, N-vinyl-epsilon-caprolactam, N-vinylsuccinimide, N-vinyl-3-methyl-2-pyrrolidone, and N-vinyl-4-methyl-2-pyrrolidone. In one embodiment, lactam monomers are unsubstituted 4 to 6 membered lactam rings. In another embodiment, lactam monomers are repeat units derived from N-vinyl-2-pyrrolidinone, N-vinyl-2-piperidone, N-vinyl-epsilon-caprolactam, and N-vinylsuccinimide. In yet another embodiment, lactam monomers are derived from N-vinyl-2-pyrrolidinone.

In addition to lactam monomers, the lactam polymer may be comprised of repeat units derived from non-lactam monomers. Suitable non-lactam monomers include but are not limited to methyl methacrylate, methacrylic acid, styrene, butadiene, acrylonitrile, 2-hydroxyethyl methacrylate, acrylic acid, methyl acrylate, methyl methacrylate, vinyl acetate, N,N-dimethylacrylamide, N-isopropylacrylamide and poly(ethylene glycol) monomethacrylates, combinations thereof and the like. In one embodiment, the non-lactam monomers are methacrylic acid, acrylic acid, acetonitrile and mixtures thereof. In one embodiment, a functionalized lactam polymer which is used for the preparation of the crosslinked lactam polymers contains at least about 10% lactam repeat units, i.e., e.g., at least about 30% lactam repeat units or at least about 50% lactam repeat units. As used herein, “functionalized lactam polymer” shall mean lactam polymers having functional groups such as, for example, hydroxyl or acrylate.

In another embodiment, hydroxyl-functionalized lactam polymers may be made by first dissolving the lactam polymer in an effective amount of a polyol, which also serves as the solvent, in the presence of an effective amount of a metal catalyst. As used herein, an “effective amount” of polyol shall be at least the amount of polyol required to substantially dissolve the lactam polymer, and may range from about 10% to about 99 wt %, i.e., e.g., between about 40% and about 90%, based upon the total weight of all components in the reaction mixture. The metal catalyst may be added to the lactam polymer before, after, or simultaneously with the addition of the metal catalyst thereto.

Suitable polyols include, but are not limited to, 1,3-propanediol, 1,4-butanediol, 1,5-pentanediol, 1,6-hexanediol, 1,8-octanediol, 1,12-dodecanediol, ethylene glycol, diethylene glycol, triethylene glycol, tetraethylene glycol, pentaethylene glycol, hexaethylene glycol, heptaethylene glycol, and poly(ethylene glycol), glycerol, erythritol, pentaerythritol, ethoxylated pentaerythritol, dipentaerythritol, xylitol, ribitol, sorbitol, trimethylolpropane, 1,2,6-hexanetriol, 1,2,4-butanetriol and combinations thereof. In one embodiment, the polyol is ethylene glycol, glycerol, or a mixture thereof.

As used herein, an “effective amount” of metal catalyst shall be at least the amount of metal catalyst required to expedite the reaction between the lactam and polyol to the desired rate, and may range from, based upon the ratio of moles of lactam polymer to moles of catalyst, from about 100 to about 10,000 moles lactam polymer : about 1 mole catalyst, i.e., e.g., between about 1000 to about 5000 moles lactam polymer: about 1 mole catalyst.

Suitable metal catalysts include, but are not limited to, tin catalysts; aluminum catalysts such as aluminum isopropoxide; calcium catalysts such as calcium acetylacetonate; manganese catalysts such as manganese chloride; lanthanide catalysts such as yttrium isopropoxide; antimony catalysts such as antimony trioxide or antimony trihalides; zinc catalysts such as zinc lactate; and tin catalysts such as tin alkanoates, tin alkoxides, tin oxides, tin halides and tin carbonates; and mixtures thereof. Suitable tin catalysts include, but are not limited to, stannous octoate (tin (II) 2-ethyl-hexanonate), dibutyltinoxide, tin (II) chloride and the like, and mixtures thereof. In one embodiment, the tin catalyst is stannous octoate.

Accordingly, the reaction may be conducted at any temperature at which the selected polyol solvent is in the liquid state. Suitable temperatures include those between about 20° C. and about 150° C., i.e., e.g., between about 40° C. and about 110° C. Pressure is not critical and ambient pressure may be used. One skilled in the art would readily appreciate that the reaction time will vary depending upon, for example, the type and amount of catalyst selected, the type and amount of polyol selected, and the temperature selected; however, suitable reaction times may include up to about 5 days, i.e., e.g., from about 1 day to 2 days.

In one embodiment, the resultant hydroxyl-functionalized lactam polymer product has hydroxyl groups along its polymer backbone in an amount, based upon the total mole content of lactam groups in the lactam polymer, from about 1 mole percent to about 99 mole percent, i.e., e.g., from about 1 mole percent to about 20 mole percent. For example, a hydroxyl-functionalized lactam polymer with a number average molecular weight of 100,000, and which contains about 5 mole percent hydroxyl groups will have, on average, approximately 45 hydroxyl groups per 900 monomeric lactam repeat units.

The resulting hydroxyl-functionalized lactam polymers may then further be reacted with hydroxyl reactive compounds containing at least one acrylate group in order to form acrylate-functionalized lactam polymers. Details of the conditions for this reaction are disclosed in, for example, the '235 Publication. For example, Example 6 of the '235 Publication describes the acryloylation of the hydroxyl groups on the hydroxyl-functionalized lactam polymer. Furthermore, Example 7 of the '235 Publication describes the reaction of the hydroxyl groups on the hydroxyl-functionalized lactam polymer with 2-isocyanatoethyl methacrylate to form the acrylate-functionalized lactam polymers.

In one embodiment, the acrylate-functionalized lactam polymers have a number average molecular weight of at least about 1,000 Daltons. In another embodiment, the number average molecular weight of the acrylate-functionalized lactam polymersis greater than about 2,000 Daltons. In yet another embodiment, the number average molecular weight of the acrylate-functionalized lactam polymers is about 2,000 to about 300,000 Daltons, i.e., e.g., between about 2,000 to about 100,000 Daltons or between about 2,000 to about 40,000 Daltons.

In one embodiment, the acrylate-functionalized lactam polymer may be crosslinked by reaction with a Michael Addition type acrylate reactant. Michael Addition type acrylate reactants can be di- or polyfunctional, and are described generally in Lutolf, M. P., et. al., 12(6) J. A. Bioconjugate Chem. 1051 (2001); U.S. Pat. No. 6,958,212; and Smith, M. B., March, J.; “March's Advanced Organic Chemistry Reactions, Mechanisms, and Structure, 1022-1024 (5^{th} Ed. 2001). See also, for example, Lutolf, M. P; Hubbell, J. A., 4(3) Biomacromolecules 713 (2003); Lutolf, M. P., et. al., 12(6) Bioconjugate Chem. 1051 (2001); Vernon, B., et. al.; 64A J Biomed Mater Res Part A 447 (2003) (preparation of chemically crosslinked, degradable hydrogels by Michael Addition of multifunctional thiol-containing compounds with end-functionalized polymers containing unsaturated groups such as PEG-diacrylates).

In one embodiment, the Michael Addition type acrylate reactant is an acrylate-reactive thiol. Suitable acrylate-reactive thiols include, but are not limited to, proteins containing cysteine residues, albumin, glutathione, 3,6-dioxa-1,8-octanedithiol (TCI America, Portland, Oreg.), oligo (oxyethylene) dithiols, pentaerythritol poly(ethylene glycol) ether tetra-sulfhydryl, Sorbitol poly(ethylene glycol) ether hexa-sulfhydryl (with a preferred molecular weight in the range of about 5,000 to 20,000, SunBio Inc., Orinda, Calif.), dimercaptosuccinic acid (Epochem Co. Ltd, Shangai, China), dihydrolipoic acid (HOOC—(CH2)4—CH(SH)—CH2—CH2SH, Geronova Research Inc., Reno, Nev.), dithiothreitol (HS—CH2—CH(OH)—CH(OH)—CH2SH, Sigma Aldrich Co., Milwaukee, Wis.), trimethylolpropane tris(3-mercaptopropionate) (Sigma Aldrich Co., Milwaukee, Wis.), pentaerythritol tetrathioglycolate, pentaerythritol tetra(3-mercaptopropionate), dipentaerythritol hexakis(thioglycolate) (DPHTG) (Austin Chemicals, Buffalo Grove, Ill.), and ethoxylated pentaerythritol (PP150) tetrakis(3-mercapto propionate) (Austin Chemicals, Buffalo Grove, Ill.), and mixtures thereof. In one embodiment, the acrylate-reactive thiols are pentaerythritol tetrathioglycolate, pentaerythritol tetra(3-mercaptopropionate), dipentaerythritol hexakis(thioglycolate) (DPHTG) (Austin Chemicals, Buffalo Grove, Ill.), and ethoxylated pentaerythritol (PP150) tetrakis(3-mercapto propionate) (Austin Chemicals, Buffalo Grove, Ill.). The most preferred acrylate-reactive thiol is ethoxylated pentaerythritol (PP150) tetrakis(3-mercapto propionate) (Austin Chemicals, Buffalo Grove, Ill.).

One of skill in the art will recognize that alternative Michael Addition type acrylate reactants are also suitable and include, but are not limited to, amines, enamines, nitriles, imidazole and its derivatives, acetoacetates, ketones, enolates, dithiocarbamate anions, nitroalkanes, and mixtures thereof.

The crosslinked acrylate functionalized lactam polymers of the present invention can be prepared by dispersing the acrylate-functionalized lactam polymer in the presence of a Michael Addition type acrylate reactant in a basic aqueous medium at a temperature between about room temperature and about 60° C., i.e., e.g., between about 25° C. and about 40° C. The pH of the basic aqueous medium should be greater than about 7, i.e., e.g., in the range of about 7.5 to about 11, i.e., in the range of about 8 to about 10.5 or in the range of about 8.5 to about 10.5. The basic pH is provided by addition of an organic or inorganic base, and/or by inclusion of a buffer system in an amount that provides a pH in the desired range. Other chemical synthesis modifiers can be utilized to effect reactivity e.g., catalysts, activators, initiators, temperature or other stimuli. Various biocompatible solvents including, but not limited to, dimethyl sulfoxide, N-methyl-2-pyrrolidone, glycerol, triacetin, propylene glycol, water, TWEEN (Polysorbates) (ICI Americas Inc. Bridgewater, N.J.), poly(ethylene glycol)s, and combinations thereof may also be incorporated, if necessary in a 0.2 to 100-fold amount (by weight) of the co-reactants.

In one embodiment, the crosslinked polymer reaction conditions are those in which the acrylate-functionalized lactam polymer is mixed with the Michael Addition type acrylate reactant in aqueous basic medium having a pH of about 8.5 to about 10 and at a temperature of about 25° C. to about 40° C.

It may be desirable, and in some cases essential, to use molar equivalent quantities of the reactants. In some cases, molar excess of a reactant may be added to compensate for side reactions such as reactions due to hydrolysis of the ester moiety.

It is also suitable to prepare the crosslinked polymers of the present invention in organic solvents, especially in the case where reactants are solids and not readily water-soluble or water dispersable. Aqueous solutions, organic solvents, poly(ethylene glycol)s, or aqueous-organic mixtures may also be added to improve the reaction speed or to adjust the viscosity of a given formulation.

In another embodiment, the hydroxyl-functionalized lactam polymer may be further reacted with an effective amount of hydroxyl reactive compounds or polymerization agents under conditions sufficient in order to form hydroxyl polymer derivatives. Such hydroxyl polymer derivatives are useful as, for example, bioadhesives or sealants for biomedical applications. As used herein, an “effective amount of hydroxyl reactive compounds or polymerization agents” shall mean at least an amount equivalent to the moles of hydroxyl groups in the hydroxyl functionalized lactam polymer, and may range up to about 10 times the amount of moles of hydroxyl groups in excess.

In one embodiment, the hydroxyl reactive compound contains at least one additional reactive moiety. This type of hydroxyl reactive compound is useful when it is desirable to have the resulting a hydroxyl polymer derivative crosslink upon exposure to water, living tissue, or other reactive compounds. Suitable hydroxyl reactive compounds may contain an additional reactive moiety selected from the group consisting of carbamates, acyl chlorides, sulfonyl chlorides, isothiocyanates, cyanoacrylates, oxiranes, imines, thiocarbonates, thiols, aldehydes, aziridines, azides, and mixtures thereof.

Examples of suitable hydroxyl reactive compounds include, but are not limited to acrylol chloride, 2-isocyanatoethyl methacrylate, epichlorohydrin, maleic anhydride, glutamic acid, mercaptopropionic acid, and mixtures thereof.

In one embodiment, the hydroxyl-functionalized lactam polymer may be dissolved in an effective amount of anhydrous solvent in order to prevent side reactions of the reactive moieties prior to the addition of the hydroxyl reactive compounds or polymerization agents thereto. As used herein, an “effective amount of anhydrous solvent” shall mean at least the amount required to substantially dissolve the hydroxyl-functionalized lactam polymer, and may be an amount of about 10% to about 99 wt %, i.e., e.g., between about 40% to about 90%, based upon the weight of the hydroxyl-functionalized lactam polymer. Examples of suitable anhydrous solvents include, but are not limited to, 1,4-dioxane, N,N-dimethylacetamide (DMAC), N,N-dimethylformamide (DMF), methyl sulfoxide (DMSO), N-methyl pyrrolidone (NMP), and mixtures thereof.

For example, a hydroxyl-functionalized lactam polymer may be dissolved in an effective amount of anhydrous 1,4-dioxane then reacted with 2 equivalents of a diisocyanate, such as 2,2,3,3,4,4,5,5-octafluorohexamethylene-1,6-diisocyanate, to form a hydroxyl polymer derivative with pendent isocyanate groups. The hydroxyl polymer derivative with pendent isocyanate groups would then form a crosslinked network when contacted with water, bodily tissue, or other reactive compounds such as, amines, thiols, hydroxyl containing compounds, and the like.

Suitable hydroxyl-reactive compounds bearing reactive moieties include diisocyanates such as 2,2,3,3,4,4,5,5-octafluorohexamethylene-1,6-diisocyanate, hexamethylene diisocyanate (HMDI), 2,2,3,3,4,4-hexafluoropentamethylene-1,5-diisocyanate, tolylene-2,4-diisocyanate (TDI), isophorone diisocyanate (IPDI), p-phenylene diisocyanate, lysine diisocyanate (LDI), lysine triisocyanate (LTI), and combinations thereof and the like.

In another embodiment, the hydroxyl-functionalized lactam polymer may be further reacted under conditions sufficient with an effective amount of a polymerizable agent comprising at least one polymerizable group in order to form hydroxyl polymer derivatives. As used herein, “polymerizable groups” shall mean any moiety that can undergo anionic, cationic or free radical polymerization.

Suitable free radical polymerizable groups include, but are not limited to, acrylates, styryls, vinyls, vinyl ethers, C₁₋₆alkylacrylates, acrylamides, C₁₋₆alkylacrylamides, N-vinyllactams, N-vinylamides, C₂₋₁₂alkenyls, C₂₋₁₂alkenylphenyls, C₂₋₁₂ alkenylnaphthyls, C₂₋₆alkenylphenylC₁₋₆alkyls, or copolymers or mixtures thereof.

Suitable polymerizable agents comprising at least one cationic reactive group include, but are not limited to, vinyl ethers, 1,1-dialkyl olefins, epoxide groups, mixtures thereof and the like.

Suitable polymerizable agents comprising at least one anionic reactive group include, but are not limited to, acrylates, methacrylates, styryls, epoxide groups, mixtures thereof and the like.

In one embodiment, the polymerization agent is selected from the group consisting of methacrylates, acrylates, methacrylamides, acrylamides, and copolymers and mixtures thereof.

In one embodiment, the polymerizable agent may be a photo-polymerizable agent, which includes but is not limited to acryloyl chloride, methacryloyl chloride, methacrylic anhydride, methacrylic acid, acrylic acid, 3-isopropenyl-alpha,alpha-dimethylbenzyl isocyanate, 2-isocyanatoethyl methacrylate) or copolymers or mixtures thereof.

In one embodiment, the hydroxyl functionalized lactam polymer can be further reacted under conditions sufficient with an effective amount of hydroxyl-reactive biologically active agents to form polymeric prodrugs which can be used as implantable devices. The biologically active agent may be released from the polymeric prodrug upon hydrolytic cleavage of the hydroxyl polymer derivative-agent linkage site. In one embodiment, the polymer prodrug contains the biologically active agent covalently linked to the hydroxyl polymer derivative via a spacer group, and the biologically active agent may be released therefrom upon hydrolysis of bonds linking the spacer group to the agent or the hydroxyl polymer derivative to agent, or both. When the biologically active agent is covalently linked as set forth above, it can then be released in a controlled manner by hydrolysis under physiological conditions.

Suitable hydroxyl-reactive biological active agents include any biological active agents that can be linked to or dispersed in or coated onto the hydroxyl polymer derivative. Accordingly, any biologically active agents which can react with a hydroxyl group on the hydroxyl polymer derivative to form a covalent bond, without undergoing substantial degradation or side reactions may be used. Examples of suitable hydroxyl-reactive biological active agents include, but are not limited to, thosein the following therapeutic categories: ACE-inhibitors; anti-anginal drugs; anti-arrhythmias; anti-asthmatics; anti-cholesterolemics; anti-convulsants; anti-depressants; anti-diarrhea preparations; anti-histamines; anti-hypertensive drugs; anti-infectives; anti-inflammatory agents; anti-lipid agents; anti-manics; anti-nauseants; anti-stroke agents; anti-thyroid preparations; anti-tumor drugs; anti-tussives; anti-uricemic drugs; anti-viral agents; acne drugs; alkaloids; amino acid preparations; anabolic drugs; analgesics; anesthetics; angiogenesis inhibitors; antacids; anti-arthritics; antibiotics; anticoagulants; antiemetics; antiobesity drugs; antiparasitics; antipsychotics; antipyretics; antispasmodics; antithrombotic drugs; anxiolytic agents; appetite stimulants; appetite suppressants; beta blocking agents; bronchodilators; cardiovascular agents; cerebral dilators; chelating agents; cholecystokinin antagonists; chemotherapeutic agents; cognition activators; contraceptives; coronary dilators; cough suppressants; decongestants; deodorants; dermatological agents; diabetes agents; diuretics; emollients; enzymes; erythropoietic drugs; expectorants; fertility agents; fungicides; gastrointestinal agents; growth regulators; hormone replacement agents; hyperglycemic agents; hypnotics; hypoglycemic agents; laxatives; migraine treatments; mineral supplements; mucolytics; narcotics; neuroleptics; neuromuscular drugs; NSAIDS; nutritional additives; peripheral vasodilators; prostaglandins; psychotropics; renin inhibitors; respiratory stimulants; steroids; stimulants; sympatholytics; thyroid preparations; tranquilizers; uterine relaxants; vaginal preparations; vasoconstrictors; vasodilators; vertigo agents; vitamins; and wound healing agents.

Suitable reaction conditions include the use of an effective amount of a solvent that is co-miscible with the hydroxyl functionalized lactam polymer and the hydroxyl-reactive biologically active agent. As used herein, an “effective amount” of such a solvent shall mean at least an amount in which the hydroxyl polymer and the biologically active agent will dissolve, and may range, from about 10 wt % to about 99 wt %, i.e., e.g., between about 40 wt % and about 90 wt %, based upon the total weight of all components in the reaction mixture. Examples of such suitable solvents include, but are not limited to, water, N,N-dimethylacetamide (DMAC), N,N-dimethylformamide (DMF), 1,4-dioxane, methyl sulfoxide (DMSO), N-methyl pyrrolidone (NMP), combinations thereof and the like.

One skilled in the art would readily appreciate that the reaction should proceed at a temperature that effectively facilitates the reaction rate without significantly denaturing the biological activity of the drug, and may be effected by, for example the type and amount of hydroxyl-reactive biologically active agent selected, the type and amount of hydroxyl polymer derivative selected, and the like, but typically may range from about 0° C. to about 100° C. Electrophilic addition or nucleophilic substitution reactions between lactam-OH hydroxyl groups and biologically active agent result in the formation of the polymeric prodrug.

The crosslinked polymers produced in accordance with the present invention can have various physical forms such as liquid, wax, solid, semi-solid, gels such as hydrogels, elastic solid, viscoelastic solid (like gelatin), a viscoelastic liquid that is formed of gel microparticles or even a viscous liquid of a considerably higher viscosity than any of the reactants when mixed together. The term “gel” refers to the state of matter between liquid and solid. As such, a “gel” has some of the properties of a liquid (i.e., the shape is resilient and deformable) and some of the properties of a solid (i.e., the shape is discrete enough to maintain three dimensions on a two dimensional surface.) The preferred physical forms are elastic solid or viscoelastic solid.

These crosslinked polymers may be used in a variety of different pharmaceutical and medical applications. In general, the polymers described herein can be adapted for use in any medical or pharmaceutical application where polymers are currently being utilized. For example, the polymers of the present invention are useful as tissue sealants and adhesives, in tissue augmentation (i.e., fillers in soft tissue repair), in hard tissue repair such as bone replacement materials, as hemostatic agents, in preventing tissue adhesions (adhesion prevention), in providing surface modifications, in tissue engineering applications, intraocular lenses, contact lenses, coating of medical devices, and in drug/cell/gene delivery applications. One of skill in the art having the benefit of the disclosure of this invention will be able to determine the appropriate administration of a polymer composition of the present invention.

In one embodiment, the reactions of the present invention occur in situ, meaning they occur at local sites such as on organs or tissues in a living animal or human body. In another embodiment, the reactions do not release heat of polymerization that increases local temperature to more than 60 degrees Celsius. In yet another embodiment, any reaction leading to gelation occurs within 30 minutes; in still yet another embodiment within 15 minutes; and in still yet another embodiment within 5 minutes. Such polymers of the present invention form a gel that has sufficient adhesive and cohesive strength to become anchored in place. It should be understood that in some applications, adhesive and cohesive strength and gelling are not a prerequisite.

For the reactions of the present invention that occur in situ, the reactants utilized in the present invention are generally delivered to the site of administration in such a way that the reactants come into contact with one another for the first time at the site of administration, or immediately preceding administration. Thus, in one embodiment, the reactants of the present invention are delivered to the site of administration using an apparatus that allows the components to be delivered separately. Such delivery systems usually involve individualized compartments to hold the reactants separately with a single or multihead device that delivers, for example, a paste, a spray, a liquid, or a solid. The reactants of the present invention can be administered, for example, with a syringe and needle or a variety of devices. It is also envisioned that the reactants could be provided in the form of a kit comprising a device containing the reactants; the device comprising an outlet for said reactants, an ejector for expelling said reactants and a hollow tubular member fitted to said outlet for administering the reactants into an animal or human.

Alternatively, the reactants can be delivered separately using any type of controllable extrusion system, or they can be delivered manually in the form of separate pastes, liquids or dry powders, and mixed together manually at the site of administration. Many devices that are adapted for delivery of multi-component compositions are well known in the art and can also be used in the practice of the present invention.

Alternatively, the reactants of the present invention can be prepared in an inactive form as either a liquid or powder. Such reactants can then be supplied in a premixed form and activated after application to the site, or immediately beforehand, by applying an activator. In one embodiment, the activator is a buffer solution that will activate the formation of the crosslinked polymer once mixed therewith.

In another embodiment, for applications where the crosslinked polymer resulting from the reactants of the present invention need not be delivered to a site and formed in situ, the crosslinked polymer can be prepared in advance and take a variety of liquid or solid forms depending upon the application of interest as previously described herein.

Optional materials may be added to one more of the reactants to be incorporated into the resultant crosslinked polymers of the present invention, or may be separately administered. Optional materials include but are not limited to visualization agents, formulation enhancers, such as colorants, diluents, odorants, carriers, excipients, stabilizers or the like.

The reactants, and therefore the crosslinked polymers of the present invention, may further contain visualization agents to improve their visibility during surgical procedures. Visualization agents may be selected from among any of the various colored substances or dyes suitable for use in implantable medical devices, such as Food Drug & Cosmetic (FD&C) dyes number 3 and number 6, eosin, methylene blue, indocyanine green, or dyes normally found in synthetic surgical sutures. In one embodiment, the visualization agent is green, blue, or violet. The visualization agent may or may not become incorporated into the polymer. In one embodiment, the visualization agent does not have a functional moiety capable of reacting with the reactants of the present invention.

Additional visualization agents may be used such as fluorescent compounds (e.g., fluorescein, eosin, green or yellow fluorescent dyes under visible light), x-ray contrast agents (e.g., iodinated compounds) for visibility under x-ray imaging equipment, ultrasonic contrast agents, or magnetic resonance imaging (MRI) contrast agents (e.g., Gadolinium containing compounds).

The visualization agent may be used in small quantities, in one embodiment less than 1 percent (weight/volume); in another embodiment less that 0.01 percent (weight/volume); and in yet another embodiment less than 0.001 percent (weight/volume).

The examples below serve to further illustrate the invention, and should not be construed to limit the scope of the invention. The scope of the invention is defined by the appended claims. In the examples, unless expressly stated otherwise, amounts are by weight.

### EXAMPLES

### Example 1

### Synthesis of Hydroxyl Functionalized Polyvinylpyrrolidone (PVP-OH)

143 grams (1.29 moles) of polyvinylpyrrolidone (K25, MW about 30,000, Fluka, Milwaukee, Wis.) was dissolved in 888 grams of triethylene glycol (Aldrich, Milwaukee, Wis.) in a 4-liter beaker equipped with a mechanical stirring apparatus. 48.7 grams (1.29 moles) of sodium borohydride (VenPure AF granules, 98+%, Aldrich, Milwaukee, Wis.) was added to the PVP solution over a 1-hour period at room temperature. Substantial bubbling was observed. The reaction was heated to 110° C. and stirred for 5 hours. 500 milliliters of distilled water were added to the hot reaction mixture. The polymer was dialyzed against distilled water for 5 days and then against 2-propanol for 2 days using 1000 molecular weight cut-off dialysis membrane (Cellulose, Spectum Laboratories, Rancho Dominguez, Calif.). The polymer was precipitated in hexanes:isopropyl ether (50:50 volume/volume) to yield a white solid having a number average molecular weight of 8,000 and weight average molecular weight of 24,500 (gel permeation chromatography, using hexafluoroisopropanol (HFIP) and poly(2-vinylpyridine) standards). The hydroxyl number (OH#) was determined by titration [OH#=53.4 milligrams potassium hydroxide/gram sample, hydroxyl equivalent weight (EW)=1,050 grams/mole].

### Synthesis of Acrylate Functionalized Polyvinylpyrrolidone (PVP-acrylate)

4.5 grams (41 millimoles of monomer units, 4.3 millimoles of OH) of the PVP-OH was dissolved in 250 milliliters of anhydrous N,N-dimethylacetamide in a 500 milliliter, 2 necked, round bottom flask equipped with a nitrogen inlet, rubber septum, and magnetic stirring bar. 0.39 grams (4.3 millimoles) of acryloyl chloride (Aldrich, Milwaukee, Wis.) and 10 milligrams of catechol (Aldrich, Milwaukee, Wis.) were added to the polymer solution. 1.3 grams (13 millimoles) of triethylamine (Fluka, Milwaukee, Wis.), were added and the reaction mixture was then stirred at 70° C. for 6 hours. The polymer solution was filtered to remove the hydrochloride salt and then precipitated three times from isopropyl ether to yield a solid polymer containing approximately 3 mole percent acrylate groups as confirmed by ¹H NMR spectroscopy shown in FIG. 1. ¹H NMR (CDCl₃) delta=6.41-6.29 (bm, 1H, acrylate vinyl), 6.13-6.01 (bm, 1H, acrylate vinyl), 5.85-5.66 (bm, 1H, acrylate vinyl), 4.18-3.44 (bm, 1H, PVP methine proton), 3.43-3.01 (bm, 2H, PVP), 2.49-1.28 (bm, 6H, PVP).

### Synthesis of First Crosslinked Polymer

451 milligrams of the PVP-acrylate was dissolved in 3.24 grams of borate buffer solution (pH=9.0, Fluka, Milwaukee, Wis.) in a 20-milliliter glass scintillation vial. 67 milligrams (55.8 micromoles) of ethoxylated pentaerythritol (PP150) tetrakis (3-mercaptopropionate) (Avg. MW=1201.5, FAO Austin Chemical Company Inc., Benseville, Ill.) was added to the reaction mixture at room temperature. The reaction mixture gelled within 1 minute forming a crosslinked hydrogel.

### Synthesis of Second Crosslinked Polymer

0.71 grams of the PVP-acrylate was dissolved in 1.6 grams of borate buffer solution (pH=9.0, Fluka, Milwaukee, Wis.) in a 5-milliliter glass vial. 69 milligrams (57.4 micromoles) of ethoxylated pentaerythritol (PP150) tetrakis(3-mercaptopropionate) (Avg. MW=1201.5, FAO Austin Chemical Company Inc., Benseville, Ill.) was added to the reaction mixture at room temperature and was shaken on a vortex stirrer. The reaction mixture gelled within 24 hours to form a crosslinked hydrogel.

### Synthesis of Third Crosslinked Polymer

0.33 grams of the PVP-acrylate was dissolved in 321 milligrams of borate buffer solution (pH=9.0, Fluka, Milwaukee, Wis.) in a 5-milliliter glass vial. 93 milligrams (77.6 micromoles) of ethoxylated pentaerythritol (PP150) tetrakis(3-mercaptopropionate) (Avg. MW=1201.5) was added to the reaction mixture at room temperature and was shaken on a vortex stirrer. The reaction mixture gelled within 2 hours to form a crosslinked hydrogel.

### Synthesis of Fourth Crosslinked Polymer

0.82 grams of PVP-acrylate from Example 1b was dissolved in 2.8 grams of borate buffer solution (pH=9.0, Fluka, Milwaukee, Wis.) in a 5-milliliter glass vial. 173 milligrams (144 micromoles) of ethoxylated pentaerythritol (PP150) tetrakis(3-mercaptopropionate) (Avg. MW=1201.5) was added to the reaction mixture at room temperature and was shaken on a vortex stirrer. The reaction mixture gelled overnight to form a crosslinked hydrogel.

### Example 2

### Synthesis of Hydroxyl Functionalized Polyvinylpyrrolidone (PVP-OH)

100 grams (0.90 millimoles) of polyvinylpyrrolidone (K30, average molecular weight of about 40,000, Fluka, Milwaukee, Wis.) was dissolved in 700 milliliters of 2-propanol (Aldrich, Milwaukee, Wis.) in a 4-liter beaker equipped with a mechanical stirring apparatus. 34 grams (0.90 moles) of sodium borohydride (VenPure AF granules, 98+%, Aldrich, Milwaukee, Wis.) was added to the PVP solution over a 1-hour period at room temperature. Substantial bubbling was observed. The reaction was heated to 50° C. and stirred for 16 hours. 500 milliliters of distilled water were added to the reaction mixture. The polymer was dialyzed against distilled water for 7 days, methyl alcohol for 2 days, and 2-propanol for 1 day using 1000 molecular weight cut-off dialysis membrane (Cellulose, Spectum laboratories, Rancho Dominguez, Calif.). The polymer was precipitated in isopropyl ether:acetone (50:50 volume/volume) to yield a white solid with OH#=20.5 milligrams KOH/gram sample and hydroxyl equivalent weight (EW)=2,700 grams/mole.

### Synthesis of Acrylate Functionalized Polyvinylpyrrolidone (PVP-acrylate)

25.2 grams (227 millimoles of monomer units, 9.3 millimoles of OH) of the PVP- was dissolved in 308 grams of anhydrous 1,4-dioxane (Aldrich, Milwaukee, Wis.) in a 500 milliliter, 2 necked, round bottom flask equipped with a nitrogen inlet, rubber septum, and magnetic stirring bar. 1.67 grams (18.4 millimoles) of acryloyl chloride and 20 milligrams of hydroquinone (Aldrich, Milwaukee, Wis.) were added to the polymer solution. 5.60 grams (55.3 millimoles) of triethylamine was added and the reaction mixture was then stirred at 70° C. for 6 hours. The polymer solution was filtered to remove the hydrochloride salt and then precipitated three times from isopropyl ether to yield a solid polymer containing approximately 0.2-0.3 mole percent acrylate groups as confirmed by ¹H NMR spectroscopy. ¹H NMR (CDCl₃) delta=6.75-5.65 (bm, 3H, acrylate vinyls), 4.21-3.44 (bm, 1H, PVP methine proton), 3.43-2.80 (bm, 2H, PVP), 2.65-0.60 (bm, 6H, PVP).

### Synthesis of Crosslinked Polymer

2.54 grams of the PVP-acrylate was dissolved in 4.43 grams of borate buffer solution (pH=9.0, Fluka, Milwaukee, Wis.) in a 20-milliliter glass scintillation vial. 323 milligrams (269 micromoles) of ethoxylated pentaerythritol (PP150) tetrakis (3-mercaptopropionate) (Avg. MW=1201.5) was added to the reaction mixture at room temperature. The reaction mixture gelled within 24 hours at room temperature forming a crosslinked hydrogel.

### Synthesis of Crosslinked Polymer Containing Pemirolast (a Mast Cell Stabilizer)

2.0 grams of the PVP-acrylate was dissolved in 3.1 grams of borate buffer solution (pH=9.0, Fluka, Milwaukee, Wis.), 2.0 grams propylene glycol (Aldrich, Milwaukee, Wis.), and 1.8 g N-methyl-2-pyrrolidone (Aldrich, Milwaukee, Wis.) in a 20 mL glass scintillation vial. 109 mg (475 mmoles) of Pemirolast (mast cell stabilizer) (Dipharma S.p.A., Milano, Italy) and 501 milligrams (417 micromoles) of ethoxylated pentaerythritol (PP150) tetrakis (3-mercaptopropionate) (PP150-TMP) (Avg. MW=1201.5) were added to the reaction mixture at room temperature. The reaction mixture was shaken for 2 minutes using a vortex mixer and then poured into a 70 millimeter diameter aluminum dish. The film gelled within 30 minutes at room temperature.

### In Vitro Release of Pemirolast from Crosslinked Polymer

After 6.5 hours of adding PP150-TMP to the reaction mixture as described above, a portion of the crosslinked film (7.58 grams, 2.5 millimeters in thickness) was placed in 370 milliliters phosphate buffer solution (pH 7.4, Sigma-Aldrich, Milwaukee, Wis.). A 2.5 milliliter aliquot was removed at each time point and replaced with 2.5 milliliters fresh buffer solution. Pemirolast release was quantified via UV/VIS spectroscopy (lambda max=256 nanometers) and the corresponding release profile is shown in Table 1.

TABLE 1

| | | Cumulative | |
|---|---|---|---|
| | | Pemirolast Release | |
| Entry # | Time (hr) | (mg) | Wt. % Release |
| 1 | 0.19 | 10 | 12 |
| 2 | 0.39 | 19 | 21 |
| 3 | 0.62 | 25 | 28 |
| 4 | 1.3 | 43 | 49 |
| 5 | 2.5 | 59 | 68 |
| 6 | 17 | 82 | 95 |

### Synthesis of Crosslinked Polymer Containing Lidocaine

1.44 grams of the PVP-acrylate was dissolved in 3.0 grams of borate buffer solution (pH=9.0, Fluka, Milwaukee, Wis.), 1.4 grams of glycerol (Aldrich, Milwaukee, Wis.), 0.46 grams of propylene glycol, and 2.1 grams of N-methyl-2-pyrrolidone in a 20 milliliter glass scintillation vial. 251 milligrams (1.07 millimoles) of Lidocaine (Sigma, Milwaukee, Wis.) and 329 milligrams (274 micromoles) of ethoxylated pentaerythritol (PP150) tetrakis (3-mercaptopropionate) (Avg. MW=1201.5) were added to the reaction mixture at room temperature. The reaction mixture was shaken for 2 minutes using a vortex mixer and then poured into a 70 millimeter diameter aluminum dish. The thick film gelled within 30 minutes at room temperature.

### In Vitro Release of Lidocaine from Crosslinked Polymer

After 3.1 hours of adding PP150-TMP to the reaction mixture described above, a portion of the crosslinked film (0.98 grams, 2.5 millimeters in thickness) was placed in 20.0 milliters phosphate buffer solution (pH 7.4, Sigma-Aldrich, Milwaukee, Wis.). A 2.5 milliliter aliquot was removed at each time point and replaced with 2.5 milliters fresh buffer solution. Lidocaine release was quantified via UV/VIS spectroscopy (lambda max=262 nanometers) and the corresponding release profile is shown in Table 2.

TABLE 2

| | | Cumulative Lidocaine Release | Wt. % Lidocaine |
|---|---|---|---|
| Entry # | Time (hr) | (mg) | Release |
| 1 | 0.15 | 1.6 | 5.8 |
| 2 | 0.33 | 4.7 | 17 |
| 3 | 0.49 | 8.6 | 32 |
| 4 | 0.66 | 10 | 37 |
| 5 | 0.84 | 12 | 43 |
| 6 | 1.0 | 13 | 46 |
| 7 | 1.6 | 16 | 58 |
| 8 | 2.2 | 18 | 67 |
| 9 | 2.9 | 21 | 76 |
| 10 | 4.5 | 25 | 90 |
| 11 | 5.6 | 27 | 97 |

### Synthesis of Hydroxyl Functionalized Polyvinylpyrrolidone (PVP-OH)

497 grams (4.47 moles) of polyvinylpyrrolidone (K15, average molecular weight of about 10,000, Fluka, Milwaukee, Wis.) was dissolved in 3 liters distilled water in a 4-liter beaker equipped with a mechanical stirring apparatus. 360 grams (9.5 moles) of sodium borohydride (powder, 98+%, Aldrich, Milwaukee, Wis.) was slowly added to the PVP solution over a 3-hour period at room temperature. Substantial bubbling was observed. The reaction was heated to 70° C. and stirred for 24 hours. Concentrated HCl (Fisher Scientific, Pittsburgh, Pa.) was added to lower the pH from 11 to 7. The polymer was dialyzed against distilled water for 10 days using 500 molecular weight cut-off dialysis membrane (Cellulose, Spectum Laboratories, Rancho Dominguez, Calif.). The water was removed by rotary evaporation to yield a white solid with OH#=33.3 mg KOH/gram sample and hydroxyl equivalent weight (EW)=1,680 grams/mole.

### Synthesis of Acrylate Functionalized Polyvinylpyrrolidone (PVP-acrylate)

32.3 grams (291 millimoles of monomer units, 19 millimoles of OH) of the PVP-OH was dissolved in 400 milliliters of anhydrous N,N-dimethylformamide (Aldrich, Milwaukee, Wis.) and 10 milliliters anhydrous pyridine (Aldrich, Milwaukee, Wis.) in a 500 milliliter, 2 necked, round bottom flask equipped with a nitrogen inlet, rubber septum, and magnetic stirring bar. 3.48 grams (38.4 millimoles) of acryloyl chloride, 100 milligrams 4-(dimethylamino)pyridine (0.82 millimoles) (Aldrich, Milwaukee, Wis.) and 20 milligrams of hydroquinone were added to the polymer solution. The reaction mixture was then stirred at 100° C. for 1 hour. The polymer solution was filtered to remove the hydrochloride salt and then precipitated three times from isopropyl ether to yield a solid polymer containing approximately 4-5 mole percent acrylate groups as confirmed by ¹H NMR spectroscopy. ¹H NMR (D₂O) delta=6.39-6.21 (bm, 1H, acrylate vinyl), 6.18-5.96 (bm, 1H, acrylate vinyl), 5.95-5.82 (bm, 1H, acrylate vinyl), 4.01-3.42 (bm, 1H, PVP methine proton), 3.41-2.95 (bm, 2H, PVP), 2.50-1.10 (bm, 6H, PVP).

### Synthesis of Crosslinked Polymer

2.29 grams of the PVP-acrylate was dissolved in 3.17 grams of borate buffer solution (pH=9.0) in a 20 milliliter glass scintillation vial. 650 milligrams (541 micromoles) of ethoxylated pentaerythritol (PP150) tetrakis (3-mercaptopropionate) (Avg. MW=1201.5) was added to the reaction mixture at room temperature. After 2 minutes of vortexing at room temperature the reaction mixture was poured between 2 parallel plates (diameter=40 mm). Rheology data was acquired on a Rheometrics RDA-II Rheometer using a single point dynamic time sweep test. The reaction mixture gelled within 24 hours at room temperature forming a crosslinked hydrogel.

### Example 4

### Synthesis of Acrylate Functionalized Polyvinylpyrrolidone (PVP-acrylate)

6.7 grams (60 millimoles of monomer units, 4 millimoles of OH) of the PVP-OH from Example 3 was dissolved in 400 milliliters of anhydrous 1,4-dioxane in a 500 milliliter, 2 necked, round bottom flask equipped with a nitrogen inlet, rubber septum, and magnetic stirring bar. 1.1 grams (12 millimoles) of acryloyl chloride and 3.6 grams triethylamine were added dropwise in this order. 100 milligrams of hydroquinone was added to the polymer solution and the reaction mixture was then stirred at 55° C. for 6 hours. The polymer solution was filtered to remove the hydrochloride salt and then precipitated three times from isopropyl ether:hexanes (50/50 volume/volume) to yield a solid polymer containing approximately 5-6 mole percent acrylate groups as confirmed by ¹H NMR spectroscopy. ¹H NMR (D₂O) delta=6.39-6.21 (bm, 1H, acrylate vinyl), 6.18-5.96 (bm, 1H, acrylate vinyl), 5.95-5.82 (bm, 1H, acrylate vinyl), 4.01-3.42 (bm, 1H, PVP methine proton), 3.41-2.95 (bm, 2H, PVP), 2.50-1.10 (bm, 6H, PVP).

### Synthesis of Crosslinked Polymer

1.0 gram of the PVP-acrylate was dissolved in 2 grams of borate buffer solution (pH=10.0) and 2 grams of N-methyl-2-pyrrolidone in a 2-dram glass vial. 133 milligrams (111 micromoles) of ethoxylated pentaerythritol (PP150) tetrakis (3-mercaptopropionate) (Avg. MW=1201.5) was added to the reaction mixture at ambient temperature. The reaction mixture gelled within 30 minutes at ambient temperature forming a crosslinked hydrogel.

### Example 5

### Synthesis of Hydroxyl-Functionalized Polyvinylpyrrolidone (PVP-OH) Using Glycerol and Tin Octoate

58 grams (521.9 millimoles) of polyvinylpyrrolidone (K90, Fluka, Milwaukee, Wis.) was dissolved in 619 grams (6,721 millimoles) of glycerol (Aldrich, Milwaukee, Wis.) in a 4-liter beaker equipped with a mechanical stirring apparatus. 400 μL of 0.33 molar solution of tin octoate solution in toluene was then added to the PVP solution. The solution was then heated to 110° C. and stirred for 90 hours at ambient pressure. 500 milliliters of isopropanol was then added to the reaction mixture in order to dilute the thick solution. The PVP-OH polymer was precipitated out in acetone and then dialyzed against distilled water for 7 days, water/isopropanol for 2 days, and water/methanol for 1 day, sequentially, using 100 molecular weight cut-off dialysis membrane (Cellulose, Spectum laboratories, Rancho Dominguez, Calif.). The polymer was finally precipitated one more time in acetone to yield a white solid with OH#=70 milligrams KOH/gram sample and hydroxyl equivalent weight (EW)=801.4 grams/mole. The hydroxyl functionalized PVP was characterized by ¹H NMR spectroscopy.

### Example 6

### Synthesis of Hydroxyl-Functionalized Polyvinylpyrrolidone (PVP-OH) Using Ethylene Glycol and Tin Octoate

53.6 grams (483 mmoles) of polyvinylpyrrolidone (K90, Fluka, Milwaukee, Wis.) was dissolved in 712 grams (11,471 millimoles) of ethylene glycol (Aldrich, Milwaukee, Wis.) in a 4-liter beaker equipped with a mechanical stirring apparatus. 500 μL of 0.33 molar solution of tin octoate solution in toluene was then added to the PVP solution. The solution was then heated to 95° C. and stirred for 24 hours. The PVP-OH polymer was purified by repeated washing in a (50:50 vol/vol) mixture of hexane:acetone and recovered by centrifugation followed by drying under vacuum at ambient temperature to yield a white solid with OH#=107 milligrams KOH/gram sample and hydroxyl equivalent weight (EW)=520.4 grams/mole. The hydroxyl functionalized PVP was characterized by ¹H NMR spectroscopy in deuterated dimethylformamide.

### Example 7

### Synthesis of Hydroxyl-Functionalized Polyvinylpyrrolidone (PVP-OH) Using Ethylene Glycol and Tin Octoate

53.6 grams (482.3 millimoles) of polyvinylpyrrolidone (K15, Fluka, Milwaukee, Wis.) was dissolved in excess of ethylene glycol (Aldrich, Milwaukee, Wis.) in a 4-liter beaker equipped with a mechanical stirring apparatus. 500 μL of 0.33 molar solution of tin octoate solution in toluene was then added to the PVP solution. The solution was then heated to 100° C. and stirred for 24 hours. The PVP-OH polymer was purified by dialyzing against distilled water for 7 days using 1000 molecular weight cut-off dialysis membrane (Cellulose, Spectum laboratories, Rancho Dominguez, Calif.). The hydroxyl functionalized PVP was characterized by ¹H NMR spectroscopy in deuterated chloroform.

### Example 8

### Synthesis of Hydroxyl-Functionalized Polyvinylpyrrolidone (PVP-OH) Using Ethylene Glycol and Tin Octoate

100 grams (899.8 millimoles) of polyvinylpyrrolidone (K25, Fluka, Milwaukee, Wis.) was dissolved in 791 grams (12,744 millimoles) of ethylene glycol (Aldrich, Milwaukee, Wis.) in a 4-liter beaker equipped with a mechanical stirring apparatus. 2 ml of 0.33 molar solution of tin octoate solution in toluene was then added to the PVP solution. The mixture was then heated to 125° C. and stirred for 72 hours. The polymer was precipitated in several liters of isopropyl ether, acetone, and hexanes sequentially. The PVP-OH polymer was finally dried in the vacuum oven at ambient temperature to yield a dark colored solid with OH#=41.8 milligrams KOH/gram sample and hydroxyl equivalent weight (EW)=1300 grams/mole. The hydroxyl functionalized PVP was characterized by ¹H NMR spectroscopy.

### Example 9

### Synthesis of PVP-acrylate using PVP-OH from Example 8

28.9 grams (22.2 millimoles) of polyvinylpyrrolidone (K25)-ethylene glycol adduct (equivalent weight 1300) prepared in accordance with the process set forth in Example 8 was dissolved in 300 grams of 1,4-dioxane in a 2 liter round bottom flask equipped with a mechanical stirring under ambient temperature and pressure. 50 mg of hydroquinone (Aldrich, Milwaukee, Wis.) was then added to the reaction mixture. 4 grams (44.5 millimoles) of acryloyl chloride was then added to the reaction mixture followed by 13.5 grams (133.4 millimoles) of triethylamine. The mixture was then heated at 50° C. for 20 hours followed by stirring at room temperature for 7 days. After the triethylammonium salt was removed therefrom by centrifugation, the dioxane solvent was removed from the mixture via rotoevaporation using a Rotavapor R-144 and a Waterbath B-481 (Buchi Corporation, New Castle, Del.) under aspirator vacuum. The temperature was very slowly increased from room temperature up to about 50° C. The resulting polymer was then dissolved in methanol and precipitated out in 50:50 volume: volume solution of isopropyl ether:acetone to yield a slightly brown colored polymer. The resulting polymer was found to have 3.8-4.7 mol % acrylate groups as determined by ¹H NMR spectroscopy.

### Example 10

### Synthesis of Hydroxyl-Functionalized Polyvinylpyrrolidone (PVP-OH) Using Glycerol and Tin Octoate

100 grams (899.8 millimoles) of polyvinylpyrrolidone (K25, Fluka, Milwaukee, Wis.) were dissolved in 631.5 grams (6856.7 millimoles) of glycerol (Aldrich, Milwaukee, Wis.) in a 4-liter beaker equipped with a mechanical stirring apparatus. 2 ml of 0.33 molar solution of tin octoate solution in toluene was then added to the PVP solution. The solution was then heated to 100° C. and stirred for 16 hours. The PVP-OH polymer was precipitated sequentially in several liters of isopropyl ether, acetone, and hexane, respectively. The PVP-OH polymer was finally purified by dialyzing against distilled water for 7 days using 1000 molecular weight cut-off dialysis membrane (Cellulose, Spectrum laboratories, Rancho Dominguez, Calif.). The polymer was finally precipitated one more time in acetone to yield a white solid with OH#=70 milligrams KOH/gram sample and hydroxyl equivalent weight (EW)=801.4 grams/mole.

### Example 11

### Synthesis of Methacrylate-Functionalized Polyvinylpyrrolidone (PVP-methacrylate) Using PVP-OH from Example 10

1 gram (9.0 millimoles of monomer units, 1.3 millimoles of OH) of the PVP-OH from Example 10 above was dissolved in 10 milliliters of anhydrous N,N-dimethylformamide (Aldrich, Milwaukee, Wis.) in a 20 milliliter vial equipped with a nitrogen inlet, rubber septum, and magnetic stirring bar. 0.19 grams (1.3 millimoles) of isocyanatoethylmethacrylate (Aldrich, Milwaukee, Wis.) and a drop of tin octanoate solution as catalyst were added to the polymer solution. The solution was then stirred at room temperature for 24 hours. The polymer solution was then precipitated three times from 50:50 mixture of hexane:isopropyl ether to yield a solid polymer containing approximately 1.3 mole percent methacrylate groups as confirmed by ¹H NMR spectroscopy in deuterated dimethylformamide.

### Example 12

### Synthesis of Acrylate-Functionalized Polyvinylpyrrolidone (PVP-acrylate) Using PVP-OH from Example 10

1 gram (9.0 millimoles of monomer units, 1.3 millimoles of OH) of the PVP-OH from Example 10 above was dissolved in 10 milliliters of anhydrous N,N-dimethylformamide (Aldrich, Milwaukee, Wis.) and 1.1 gram (3.9 millimoles) of anhydrous triethylamine (Aldrich, Milwaukee, Wis.) in a 20 milliliter vial equipped with a nitrogen inlet, rubber septum, and magnetic stirring bar. 0.112 grams (1.3 millimoles) of acryloyl chloride (Aldrich, Milwaukee, Wis.) and 20 milligrams of hydroquinone were added to the polymer solution. The reaction mixture was then stirred at room temperature for 24 hours. The mixture was filtered to remove the hydrochloride salt and then precipitated three times from 50:50 mixture of hexane:isopropyl ether to yield a oily polymer containing approximately 2-3 mole percent acrylate groups as confirmed by ¹H NMR spectroscopy in deuterated dimethylformamide.

### Example 13

### Synthesis of Methacrylate-Functionalized Polyvinylpyrrolidone (PVP-isopropenyl) Using PVP-OH from Example 10

1 gram (9.0 millimoles of monomer units, 1.3 millimoles of OH) of the PVP-OH from Example 10 above was dissolved in 10 milliliters of anhydrous N,N-dimethylformamide (Aldrich, Milwaukee, Wis.) in a 20 milliliter vial equipped with a nitrogen inlet, rubber septum, and magnetic stirring bar. 0.26 grams (1.3 millimoles) of 3-isopropenyl-α,α-dimethylbenzylisocyanate (Aldrich, Milwaukee, Wis.) and a drop of tin octanoate solution as catalyst were added to the polymer solution. The solution was then stirred at room temperature for 24 hours. The PVP-isopropenyl polymer was then precipitated three times from 50:50 mixture of hexane:isopropyl ether to yield a solid polymer.

### Example 14

### Synthesis of Crosslinked Polyurethane using PVP-OH from Example 10 and bis (4-isocyanatocyclohexyl) Methane (HMDI)

1 gram (9.0 millimoles of monomer units, 1.3 millimoles of OH) of the PVP-OH from Example 10 above was dissolved in 10 milliliters of anhydrous N,N-dimethylformamide (Aldrich, Milwaukee, Wis.) in a 20 milliliter vial equipped with a nitrogen inlet, rubber septum, and magnetic stirring bar. 1.1 gram (3.9 millimoles) of anhydrous bis (4-isocyanatocyclohexyl) methane (HMDI) (Aldrich, Milwaukee, Wis.) was added to the polymer solution. The solution was then stirred at room temperature for about 2 hours in order to form a crosslinked polymer gel.

### Example 15

### Preparation of Contact Lenses Using PVP-methacrylate from Example 11

In a 20 mL amber vial, 30 parts by weight of methyldi(trimethylsiloxy)sylylpropylglycerol methacrylate (SIMAA), 22 parts monomethacryloxypropyl terminated polydimethylsiloxane (MW 800-1000) (mPDMS), 31 parts N,N-dimethylacrylamide (DMA), 8.5 parts 2-hydroxyethyl methacrylate (HEMA), 0.75 parts ethyleneglycol dimethacrylate (EGDMA), 1.5 parts 2-(2′-hydroxy-5-methacrylyloxyethylphenyl)-2H-benzotriazole (Norblock 7966), 0.23 parts Bis(2,6-dimethoxybenzoyl)-2,4,4-trimethylpentylphosphine oxide (CGI 819), 29 parts tert-amyl alcohol (TAA), 11 parts PVP polyvinylpyrrolidone (2,500 molecular weight), and 4.3 parts PVP-methacrylate from Example 11 were combined to make a reaction mixture. The diluent PVP (2,500 molecular weight) made up 7.8 percent of the mass of the complete reaction mixture. The resulting reaction mixture was a clear, homogeneous solution. Polypropylene contact lens molds were filled, closed and irradiated with a total of 4 mW/cm² visible light over a 20-minute period at 47° C. The molds were opened and the lenses were released into isopropanol (IPA) and then transferred into deionized water. The lenses were clear.

We claim:

1. A crosslinked lactam polymer comprising the reaction product of a) a lactam polymer having a pendant acrylate group, and b) a Michael addition type reactant.

2. The crosslinked lactam polymer of claim 1 wherein the lactam polymer comprises repeat units derived from lactam monomers selected from the group consisting of N-vinyl-2-pyrrolidinone, N-vinyl-2-piperidone, N-vinyl-epsilon-caprolactam, N-vinyl-3-methyl-2-pyrrolidone, N-vinyl-3-methyl-2-piperidone, N-vinyl-3-methyl-2-caprolactam, N-vinyl-4-methyl-2-pyrrolidone, N-vinyl-4-methyl-2-caprolactam, N-vinyl-5-methyl-2-pyrrolidone, N-vinyl-5-methyl-2-piperidone, N-vinyl-5,5-dimethyl-2-pyrrolidone, N-vinyl-3,3,5-trimethyl-2-pyrrolidone, N-vinyl-5-methyl-5-ethyl-2-pyrrolidone, N-vinyl-3,4,5-trimethyl-3-ethyl-2-pyrrolidone, N-vinyl-6-methyl-2-piperidone, N-vinyl-6-ethyl-2-piperidone, N-vinyl-3,5-dimethyl-2-piperidone, N-vinyl-4,4-dimethyl-2-piperidone, N-vinyl-7-methyl-2-caprolactam, N-vinyl-7-ethyl-2-caprolactam, N-vinyl-3,5-dimethyl-2-caprolactam, N-vinyl-4,6-dimethyl-2-caprolactam, N-vinyl-3,5,7-trimethyl-2-caprolactam, N-vinylmaleimide, N-vinylsuccinimide and combinations thereof.

3. The crosslinked lactam polymer of claim 2 wherein the lactam polymer comprises repeat units derived from lactam monomers selected from the group consisting of N-vinyl-2-pyrrolidinone, N-vinyl-2-piperidone, N-vinyl-epsilon-caprolactam, N-vinylsuccinimide, N-vinyl-3-methyl-2-pyrrolidone, and N-vinyl-4-methyl-2-pyrrolidone and combinations thereof.

4. The crosslinked lactam polymer of claim 3 wherein the lactam polymer comprises repeat units derived from lactam monomers selected from the group consisting of N-vinyl-2-pyrrolidinone, N-vinyl-2-piperidone, N-vinyl-epsilon-caprolactam, and N-vinylsuccinimide and combinations thereof.

5. The crosslinked lactam polymer of claim 4 wherein the lactam polymer comprises repeat units derived from N-vinyl-2-pyrrolidinone.

6. The crosslinked lactam polymer of claim 2 wherein the Michael addition type reactant is an acrylate reactive thiol selected from the group consisting of proteins containing cysteine residues, albumin, glutathione, 3,6-dioxa-1,8-octanedithiol, oligo (oxyethylene) dithiols, pentaerythritol poly(ethylene glycol) ether tetra-sulfhydryl, sorbitol poly(ethylene glycol) ether hexa-sulfhydryl, dimercaptosuccinic acid, dihydrolipoic acid, dithiothreitol, trimethylolpropane tris(3-mercaptopropionate), pentaerythritol tetrathioglycolate, pentaerythritol tetra(3-mercaptopropionate), dipentaerythritol hexakis(thioglycolate), and ethoxylated pentaerythritol (PP150) tetrakis(3-mercapto propionate) and combinations thereof.

7. The crosslinked lactam polymer of claim 3 wherein the Michael addition type reactant is an acrylate reactive thiol selected from the group consisting of pentaerythritol tetrathioglycolate, pentaerythritol tetra(3-mercaptopropionate), dipentaerythritol hexakis(thioglycolate), and ethoxylated pentaerythritol (PP150) tetrakis(3-mercapto propionate) and combinations thereof.

8. The crosslinked lactam polymer of claim 4 wherein the Michael addition type reactant is an acrylate reactive thiol selected from the group consisting of pentaerythritol tetrathioglycolate, pentaerythritol tetra(3-mercaptopropionate), dipentaerythritol hexakis(thioglycolate), and ethoxylated pentaerythritol (PP150) tetrakis(3-mercapto propionate) and combinations thereof.

9. The crosslinked lactam polymer of claim 5 wherein the Michael addition type reactant is ethoxylated pentaerythritol (PP150) tetrakis(3-mercapto propionate).

10. The crosslinked lactam polymer of claim 6 wherein the lactam polymer further comprises repeat units from a non-lactam monomer selected from the group consisting of methyl methacrylate, methacrylic acid, styrene, butadiene, acrylonitrile, 2-hydroxyethyl methacrylate, acrylic acid, methyl acrylate, methyl methacrylate, vinyl acetate, N,N-dimethylacrylamide, N-isopropylacrylamide and poly(ethylene glycol) monomethacrylates, and combinations thereof.

11. The crosslinked lactam polymer of claim 7 wherein the lactam polymer further comprises repeat units from a non-lactam monomer selected from the group consisting of methacrylic acid, acrylic acid, acetonitrile and combinations thereof.

12. The crosslinked lactam polymer of claim 8 wherein the lactam polymer further comprises repeat units from a non-lactam monomer selected from the group consisting of methacrylic acid, acrylic acid, acetonitrile and combinations thereof.

13. The crosslinked lactam polymer of claim 9 wherein the lactam polymer further comprises repeat units from a non-lactam monomer selected from the group consisting of methacrylic acid, acrylic acid, acetonitrile and combinations thereof.

14. A process comprised of reacting at least one lactam polymer and a polyol in the presence of a metal catalyst to form a hydroxyl-functionalized lactam polymer.

15. The process of claim 14 wherein said polyol is selected from the group consisting of 1,3-propanediol, 1,4-butanediol, 1,5-pentanediol, 1,6-hexanediol, 1,8-octanediol, 1,12-dodecanediol, ethylene glycol, diethylene glycol, triethylene glycol, tetraethylene glycol, pentaethylene glycol, hexaethylene glycol, heptaethylene glycol, and poly(ethylene glycol), glycerol, erythritol, pentaerythritol, ethoxylated pentaerythritol, dipentaerythritol, xylitol, ribitol, sorbitol, trimethylolpropane, 1,2,6-hexanetriol, and 1,2,4-butanetriol and mixtures thereof.

16. The process of claim 15 wherein said polyol is selected from the group consisting of ethylene glycol, glycerol, and mixtures thereof.

17. The process of claim 14 wherein said polyol is present in an amount, based upon the total weight of polyol and lactam polymer, from about 10 wt % to about 99 wt %.

18. The process of claim 14 wherein said polyol is present in an amount, based upon the total weight of polyol and lactam polymer, from about 40 wt % to about 90 wt %.

19. The process of claim 14 wherein said metal catalyst is selected from the group consisting of aluminum catalysts, calcium catalysts, manganese catalysts, lanthanide catalysts, antimony, catalysts, zinc catalysts, tin catalysts, and mixtures thereof.

20. The process of claim 19 wherein said tin catalyst is selected from the group consisting of stannous octoate, dibutyltinoxide, tin (II) chloride and mixtures thereof.

21. The process of claim 20 wherein said tin catalyst is stannous octoate, and is in an amount from about 9 mole % to about 50 mole %, based upon the total moles of lactam groups in said lactam polymer.

22. The process of claim 14 wherein said metal catalyst is present in amount such that the mole ratio of lactam polymer to catalyst is about 100 to 1 to about 10,000 to 1.

23. The process of claim 14 wherein said metal catalyst is present in amount such that the mole ratio of lactam polymer to catalyst is about 1000 to 1 to about 5,000 to 1.

24. The process of claim 14 wherein said process is conducted at a temperature between about 20° C. and about 150° C.

25. The process of claim 14 wherein said process is conducted at a temperature between about 40° C. and about 110° C.

26. The process of claim 14 wherein said process is conducted for a time not to exceed about 5 days.

27. The process of claim 14 wherein said process is conducted for a time of about 24 hours to about 48 hours.

28. The process of claim 14 wherein said lactam polymer is comprised of, based upon the total amount of moles of lactam polymer, at least about 10 mole % of repeating units derived from at least one lactam group.

29. The process of claim 14 wherein said lactam polymer is comprised of, based upon the total amount of moles of lactam polymer, at least about 30% repeating units derived from at least one lactam group.

30. The process of claim 14 wherein said lactam polymer is comprised of, based upon the total amount of moles of lactam polymer, at least about 50% repeating units derived from at least one lactam group.

31. The process of claim 28 wherein said at least one lactam group is selected from the group consisting of a substituted 4 to 7 membered lactam ring, an unsubstituted 4 to 7 membered lactam ring, and combinations thereof.

32. The process of claim 28 wherein said at least one lactam group is an unsubstituted 4 to 6 membered lactam ring.

33. The process of claim 28 wherein said at least one lactam polymer contains a lactam monomer selected from the group consisting of N-vinyl-2-pyrrolidone, N-vinyl-2-piperidone, N-vinyl-2-caprolactam, N-vinyl-3-methyl-2-pyrrolidone, N-vinyl-3-methyl-2-piperidone, N-vinyl-3-methyl-2-caprolactam, N-vinyl-4-methyl-2-pyrrolidone, N-vinyl-4-methyl-2-caprolactam, N-vinyl-5-methyl-2-pyrrolidone, N-vinyl-5-methyl-2-piperidone, N-vinyl-5,5-dimethyl-2-pyrrolidone, N-vinyl-3,3,5-trimethyl-2-pyrrolidone, N-vinyl-5-methyl-5-ethyl-2-pyrrolidone, N-vinyl-3,4,5-trimethyl-3-ethyl-2-pyrrolidone, N-vinyl-6-methyl-2-piperidone, N-vinyl-6-ethyl-2-piperidone, N-vinyl-3,5-dimethyl-2-piperidone, N-vinyl-4,4-dimethyl-2-piperidone, N-vinyl-7-methyl-2-caprolactam, N-vinyl-7-ethyl-2-caprolactam, N-vinyl-3,5-dimethyl-2-caprolactam, N-vinyl4,6-dimethyl-2-caprolactam, N-vinyl-3,5,7-trimethyl-2-caprolactam, N-vinylmaleimide, vinylsuccinimide and mixtures thereof.

34. The process of claim 28 wherein said at least one lactam polymer contains a N-vinyl-2-pyrrolidone monomer.

35. The process of claim 28 wherein said lactam polymer is further comprised of repeat units derived from at least one non-lactam monomer.

36. The process of claim 35 wherein said at least one non-lactam monomer is selected from the group consisting of methyl methacrylate, methacrylic acid, styrene, butadiene, acrylonitrile, 2-hydroxyethylmethacrylate, acrylic acid, methyl acrylate, methyl methacrylate, vinyl acetate, N,N-dimethylacrylamide, N-isopropylacrylamide and polyethylene glycol monomethacrylates and combinations thereof.

37. The process of claim 35 wherein said at least one non-lactam monomer is selected from the group consisting of methacrylic acid, acrylic acid, acetonitrile and mixtures thereof.

38. The process of claim 14 further comprised of reacting said hydroxyl functionalized lactam polymer with a hydroxyl reactive compound comprising at least one acrylate group to form an acrylate-functionalized lactam polymer.

39. The process of claim 38 further comprised of reacting said acrylate-functionalized lactam polymer with a Michael addition acrylate reactant to form a crosslinked lactam polymer.

40. The process of claim 14 further comprised of reacting said hydroxyl functionalized lactam polymer with a hydroxyl reactive compound to form a hydroxyl polymer derivative.

41. The process of claim 14 further comprised of reacting said hydroxyl functionalized lactam polymer with a polymerizable agent to form a hydroxyl polymer derivative.

42. The process of claim 14 further comprised of reacting said hydroxyl functionalized lactam polymer with a hydroxyl-reactive biologically active agent to form a polymeric prodrug.
